(19) United States
(12) Patent Application Publication
(10) Pub. No.: US 2022/0242195 A1
(43) Pub. Date: Aug. 4, 2022

(54) Motor Vehicle

(71) Applicant: Bayerische Motoren Werke Aktiengesellschaft, Muenchen (DE)

(72) Inventors: Felix ARTMEIER, Muenchen (DE); Harald LATHWESEN, Mauern (DE); Stefan WIEDEMANN, Muenchen (DE)

(21) Appl. No.: 17/595,523

(22) PCT Filed: Mar. 31, 2020
(86) PCT No.: PCT/EP2020/059066

§ 371 Date: Nov. 18, 2021

(30) Foreign Application Priority Data
Jun. 4, 2019 (DE) 10 2019 114 922.3

(51) Int. Cl. B60H 1/00; B60R 11/02; B60H 1/24

(52) U.S. Cl. CPC B60H 1/00471; B60H 2001/00614; B60H 1/246; B60R 11/0229

(57) ABSTRACT

A motor vehicle has a body with has a frontseat region and a backseat region, and has at least one installation part or fixture between the frontseat region and the backseat region. The at least one installation part or fixture is provided with a fan which is fluidically connected to at least one flow duct which opens towards the backseat region.

### BACKGROUND AND SUMMARY OF THE INVENTION

The invention relates to a motor vehicle with a vehicle body having a front region and a rear region.

In the case of the temperature control of the passenger compartment of a motor vehicle of the generic type, warm air for heating purposes is usually generally introduced into the footwells, whereas cold air for cooling purposes is preferably directed by vents which are positioned at a higher location into the head or upper body region. Here, a large part of the cold air for the rear is supplied via the middle vents of the dashboard of the motor vehicle.

The air circulation in the motor vehicle is disrupted between the first seat row (front region) and the second seat row (rear region), however, by way of fittings in the vehicle, such as, for example, displays or bulkheads. If bulkheads of this type or relatively large displays are suspended in the roof region, the cooling performance in the rear is reduced considerably. In addition, the air which flows in from the front impinges on the bulkhead or the display and in the process produces a downdraft and leads to draft phenomena in the head/back region of the first seat row.

It is therefore an object of the present invention to provide a motor vehicle which makes an increased cooling performance in the rear possible and in the process preferably reduces draft phenomena in the first seat row or in the front region.

This object is achieved by way of a motor vehicle with a vehicle body which has a front region and a rear region, and which has at least one installation part between the front region and the rear region. The installation part is provided with a fan which is flow-connected to at least one flow duct which opens toward the rear region.

In detail, the motor vehicle according to the invention has a vehicle body which has a front region (front seat row) and a rear region (rear seat row). An installation part is provided between the front region and the rear region. In order to avoid the problems mentioned at the outset with regard to a reduced cooling performance in the rear region and draft phenomena in the front region, a fan is installed according to the invention in the installation part which can be, for example, a display or a bulkhead, which fan extracts the backed-up air quantity on the front side of the installation part and conducts it via one or more ducts to the rear side of the installation part and therefore cools the rear.

Although DE 198 14 581 A1 has disclosed, to this end, the provision of separate heat exchangers, possibly with associated fans, in each part region of a motor vehicle body, in particular also in the rear region, this document describes neither the problem on which the invention is based nor its solution by way of a fan which, as has been explained above, extracts the backed-up air quantity on the front side of the installation part and conducts it to the rear side of the installation part.

According to the invention, it is possible for the fan to be configured as a radial fan.

In the case of one particularly preferred embodiment, this radial fan is configured as a fan which sucks in air on one side and, in the case of a further preferred embodiment, can be configured as a DC fan.

According to the invention, it is possible for the fan to be integrated into the installation part, that is to say to be installed in the latter or also, if nothing else is possible for reasons due to the construction or space, to be also attached to the installation part.

Furthermore, it is possible according to the invention for either one flow duct or a plurality of flow ducts to be provided, depending on how large the installation part is and into which sections of the rear region cooling air or else heated air is to be introduced.

If the installation part is configured as an electronic component to be cooled or the installation part has an electronic component to be cooled of this type, it is possible, furthermore, for a part of the sucked-in air to be used as cooling air for this electronic component. To this end, intake openings can be provided on the rear side of the housing of the electronic component or of the installation part, by which intake openings cooling air can be fed to the electronic component.

Further details, features and advantages of the invention result from the following description of one exemplary embodiment on the basis of the drawings.

### BRIEF DESCRIPTION OF THE DRAWINGS

FIG. 1 shows a diagrammatically greatly simplified outline illustration of a motor vehicle according to an embodiment of the invention;

FIGS. 2 to 4 show examples of a passive and active display surround-flow means.

### DETAILED DESCRIPTION OF THE DRAWINGS

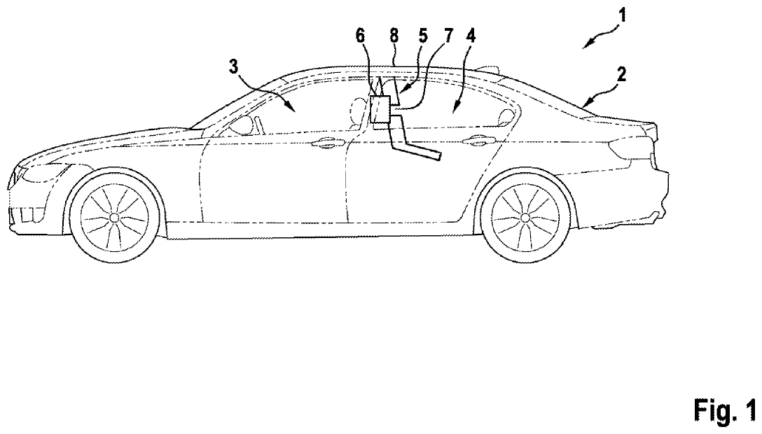

FIG. 1 shows a diagrammatically greatly simplified illustration of a motor vehicle 1 which is provided with a vehicle body 2. A front region 3 which corresponds to the front seat row is provided in the vehicle body 2. Furthermore, the vehicle body 2 has a rear region 4 which corresponds to a rear seat row but which is not shown in detail in FIG. 1.

An installation part 5 is shown in a diagrammatically greatly simplified manner between the front region 3 and the rear region 4, which installation part 5 is, in the case of the example, a display which is suspended on the roof 8 of the vehicle body 2.

The installation part 5 can be provided with a fan 6 which is flow-connected to one or a plurality of ducts which are presented in FIG. 1 by way of a single duct 7.

It is possible in this way for cooled air, which backs up on the installation part 5 on its front side which points toward the front region 3, or else heated air, to be extracted and to be introduced into the rear region 4 via the cooling duct or ducts 7.

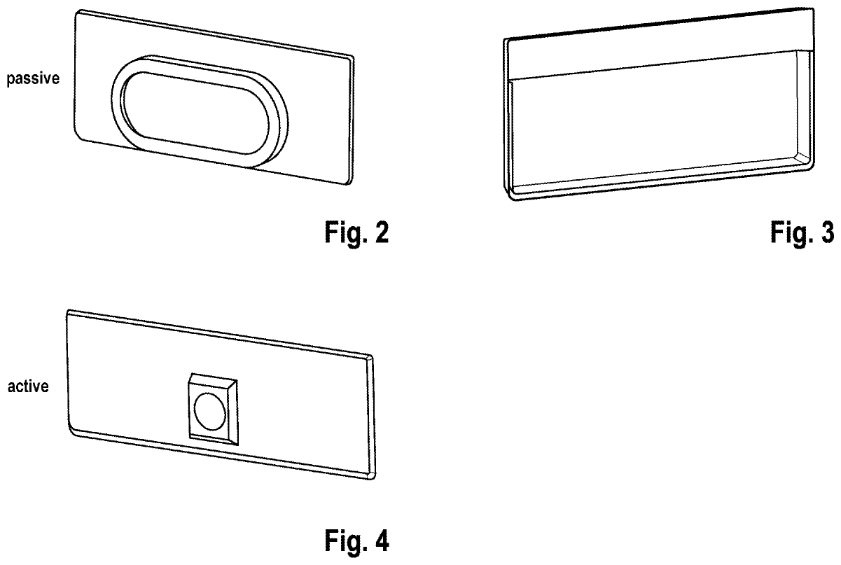

FIGS. 2 and 3 show one example of a passive installation part surround-flow means, whereas FIG. 4 illustrates an active surround-flow means.

In addition to the preceding written disclosure of the invention, reference is explicitly made hereby to the graphic illustration of the invention in FIGS. 1 to 4.

### LIST OF DESIGNATIONS

1 Motor vehicle
2 Vehicle body
3 Front region
4 Rear region
5 Installation part
6 Fan
7 Flow ducts
8 Roof/roof region

1-11. (canceled)

12. A motor vehicle, comprising:
a vehicle body, which has a front region and a rear region;
at least one installation part located between the front region and the rear region, wherein
the installation part is provided with a fan which is flow-connected to at least one flow duct which opens toward the rear region.

13. The motor vehicle according to claim 12, wherein the fan is configured as a radial fan.

14. The motor vehicle according to claim 13, wherein the radial fan is configured as a fan which sucks on one side.

15. The motor vehicle according to claim 13, wherein the radial fan is configured as a DC fan.

16. The motor vehicle according to claim 12, wherein the fan is integrated into the installation part.

17. The motor vehicle according to claim 12, wherein the fan is attached to the installation part.

18. The motor vehicle according to claim 12, wherein a plurality of flow ducts are provided.

19. The motor vehicle according to claim 12, wherein the installation part is configured as a display.

20. The motor vehicle according to claim 19, wherein the display is suspended in a roof region of the vehicle body.

21. The motor vehicle according to claim 12, wherein the installation part is configured as a bulkhead.

22. The motor vehicle according to claim 12, wherein the installation part is configured as an electronic component which is to be cooled and to which a part of the air which is sucked in by the fan is conducted as cooling air.
